(19) United States
(12) Patent Application Publication
(10) Pub. No.: US 2026/0104921 A1
(43) Pub. Date: Apr. 16, 2026

(54) METHOD FOR SCHEDULING CONCURRENT INFERENCE TASKS, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Changshuai SHI, Beijing (CN); Jianwei SUN, Beijing (CN); Rui DAI, Beijing (CN)

(73) Assignee: BEIJING BAIDU NETCOM SCIENCE TECHNOLOGY CO., LTD., Beijing (CN)

(21) Appl. No.: 19/418,665

(22) Filed: Dec. 12, 2025

(30) Foreign Application Priority Data
Jun. 18, 2025 (CN) 202510821338.1

(51) Int. Cl. G06F 9/48; G06F 9/50

(52) U.S. Cl. CPC G06F 9/4881; G06F 9/5027

(57) ABSTRACT

Provided is a method for scheduling concurrent inference tasks, an electronic device and a storage medium, relating to the fields of artificial intelligence, deep learning, large model and other technologies. The method includes: determining multiple types of computing resources and a plurality of network models required for the concurrent inference tasks, wherein the concurrent inference tasks represent a plurality of inference tasks to be processed in parallel, and each network model is used to execute at least one of the plurality of inference tasks; determining actual execution time required for each model unit in the plurality of network models to execute a task on a candidate computing resource as well as actual resource switching time corresponding to each model unit, to obtain total execution time required to execute the concurrent inference tasks; and using the total execution time to determine a target scheduling result.

### CROSS-REFERENCE TO RELATED APPLICATIONS

The present application claims priority to Chinese Patent Application No. CN202510821338.1, filed with the China National Intellectual Property Administration on Jun. 18, 2025, the disclosure of which is hereby incorporated herein by reference in its entirety.

### TECHNICAL FIELD

The present disclosure relates to the field of data processing technology, and in particular to the fields of artificial intelligence, deep learning, large model and other technologies.

### BACKGROUND

Heterogeneous computing platforms support concurrent processing of various inference tasks, improving the inference efficiency to some extent. However, how to intelligently allocate computing resources to maximize the resource utilization rate while efficiently executing inference tasks remains a problem to be solved urgently at present.

### SUMMARY

The present disclosure provides a method and an apparatus for scheduling concurrent inference tasks, a device and a storage medium.

According to one aspect of the present disclosure, provided is a method for scheduling concurrent inference tasks, including:
determining multiple types of computing resources and a plurality of network models required for the concurrent inference tasks, where the concurrent inference tasks represent a plurality of inference tasks to be processed in parallel, and each network model is used to execute at least one of the plurality of inference tasks;
determining actual execution time required for each model unit in the plurality of network models to execute a task on a candidate computing resource as well as actual resource switching time corresponding to each model unit, to obtain total execution time required to execute the concurrent inference tasks; where the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources; and
using the total execution time to determine a target scheduling result, where the target scheduling result represents at least a target computing resource to be invoked when the model unit needs to execute at least some subtasks in an inference task.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

In this way, the solution of the present disclosure can obtain the total execution time according to the determined actual execution time required for each model unit to execute the task on the candidate computing resource as well as actual resource switching time corresponding to each model unit, and then obtain the target scheduling result based on the total execution time. The above process analyzes the time consumption of each model unit when executing the task on the candidate computing resource at the model unit level, and then determines the computing resource required by each model unit according to the time consumption. Thus, the rational allocation of computing resources is achieved, and the resource utilization rate can be maximized while ensuring the rapid completion of execution of concurrent inference tasks, thereby improving the overall performance and efficiency of the system.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a first schematic flowchart of a method for scheduling concurrent inference tasks on a heterogeneous computing platform according to an embodiment of the present application;

FIG. 2 is a schematic diagram of a scene comparison chart of concurrent scheduling of computing resources by a plurality of network models according to an embodiment of the present application;

FIG. 3 is a second schematic flowchart of a method for scheduling concurrent inference tasks on a heterogeneous computing platform according to an embodiment of the present application;

FIG. 4(a) is a schematic diagram of a model structure of the network model CNN according to an embodiment of the present application;

FIGS. 4(b) and 4(c) are schematic diagrams of grouping the network layers in the network model CNN according to an embodiment of the present application;

FIG. 5 is a comparison chart before and after optimization according to an embodiment of the present application;

FIG. 6 is a third schematic flowchart of a method for scheduling concurrent inference tasks on a heterogeneous computing platform according to an embodiment of the present application;

FIG. 7 is a fourth schematic flowchart of a method for scheduling concurrent inference tasks on a heterogeneous computing platform according to an embodiment of the present application;

FIG. 8 is a schematic diagram illustrating resource contention between a model unit and another model unit on a computing resource according to an embodiment of the present application;

FIG. 9 is a schematic flowchart of the method for scheduling concurrent inference tasks on the heterogeneous computing platform in a specific example according to an embodiment of the present application;

FIG. 10 is a structural schematic diagram of an apparatus for scheduling concurrent inference tasks on a heterogeneous computing platform according to an embodiment of the present application; and

FIG. 11 is a block diagram of an electronic device used to implement the method for scheduling concurrent inference tasks on the heterogeneous computing platform according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

The solution of the present disclosure provides a method for scheduling concurrent inference tasks on a heterogeneous computing platform. This method can determine a resource scheduling result for each model unit at the model unit level of the network model, and for example, determine the computing resources required for the model unit to execute at least some subtasks in an inference task, thereby maximizing the resource utilization rate and thus improving the overall system performance and efficiency.

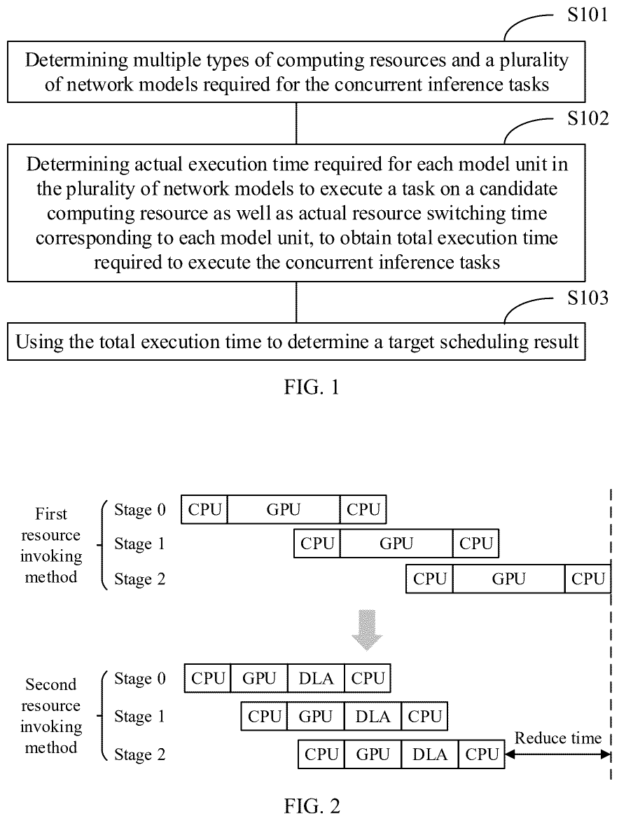

Specifically, FIG. 1 is a first schematic flowchart of a method for scheduling concurrent inference tasks on a heterogeneous computing platform according to an embodiment of the present application. This method is optionally applied in electronic devices, such as personal computers, servers, server clusters and other electronic devices.

Further, this method includes at least a part of the following content. As shown in FIG. 1, this method includes:

Step S101: determining multiple types of computing resources and a plurality of network models required for the concurrent inference tasks.

Here, the concurrent inference tasks may represent a plurality of inference tasks to be processed in parallel. Further, each network model may be specifically used to execute at least one of the plurality of inference tasks; in other words, in one example, the plurality of network models process the plurality of inference tasks in parallel, each network model corresponds to one processing branch in parallel processing and is responsible for executing one or more inference tasks on the corresponding processing branch.

Further, in a specific example, the number of network models is the same as the number of inference tasks to be processed in parallel. In this case, one network model may be specifically used to process one inference task. In other words, there is a one-to-one correspondence between network models and inference tasks.

Step S102: determining actual execution time required for each model unit in the plurality of network models to execute a task on a candidate computing resource as well as actual resource switching time corresponding to each model unit, to obtain total execution time required to execute the concurrent inference tasks.

Here, “each model unit” in the solution of the present disclosure specifically refers to each model unit among all model units in the plurality of network models. In other words, “each model unit” is not limited to all model units in one network model. Thus, the solution of the present disclosure can consider the total time cost required for parallel inference tasks from a macro perspective, that is, from all model units, thereby laying the foundation for subsequently maximizing the resource utilization rate and maximizing the improvements in the overall system performance and efficiency.

It should be noted that, in one example, if the computing resource required for the current model unit to execute a task is different from the computing resource required for the previous model unit to execute a task, then there is a need to switch resources. In this case, the resource switch will also generate the switching time, where the switching time may include the transition-out time and the transition-in time. Conversely, if the computing resource required for the current model unit to execute a task is the same as the computing resource required for the previous model unit to execute a task, then there is no need to switch resources. In this case, the resource switching time is specifically zero.

Based on this, in one example, the actual resource switching time may be specifically represented as: the transition-in time required for the model unit to switch from another computing resource to the candidate computing resource, and/or the transition-out time required to switch from the candidate computing resource to another computing resource after completing the task. Here, the candidate computing resource is one of the multiple types of computing resources.

For example, in one example, the actual resource switching time represents the transition-in time required for the model unit to switch from another computing resource to the candidate computing resource; or, in another example, the actual resource switching time represents the transition-out time required to switch from the candidate computing resource to another computing resource after completing the task; or, in yet another example, the actual resource switching time represents the transition-in time required for the model unit to switch from another computing resource to the candidate computing resource, and the transition-out time required to switch from the candidate computing resource to another computing resource after completing the task.

It should be noted that whether the actual resource switching time needs to include the transition-in time or the transition-out time or the transition-in time plus the transition-out time can be determined based on the actual situation. For example, in an actual scenario, if the transition-in time is much longer than the transition-out time, the actual resource switching time may specifically include the transition-in time while ignoring the transition-out time; similarly, if the transition-out time is much longer than the transition-in time, the actual resource switching time may specifically include the transition-out time while ignoring the transition-in time. Alternatively, if the transition-out time and transition-in time are of the same time magnitude, then the actual resource switching time may specifically include the transition-in time plus the transition-out time.

Step S103: using the total execution time to determine a target scheduling result.

Here, the target scheduling result represents at least a target computing resource to be invoked when the model unit needs to execute at least some subtasks in an inference task.

Further, in a specific example, the target scheduling result also includes the task execution time, such as the task start time corresponding to the model unit; in other words, in this example, the target scheduling result may indicate at what time and using what target computing resource to execute the task that the model unit needs to execute.

In this way, the solution of the present disclosure can obtain the total execution time according to the determined actual execution time required for each model unit to execute the task on the candidate computing resource as well as actual resource switching time corresponding to each model unit, and then obtain the target scheduling result based on the total execution time. The above process analyzes the time consumption of each model unit when executing the task on the candidate computing resource at the model unit level, and then determines the computing resource required by each model unit according to the time consumption. Thus, the rational allocation of computing resources is achieved, and the resource utilization rate can be maximized while ensuring the rapid completion of execution of concurrent inference tasks, thereby improving the overall performance and efficiency of the system.

Moreover, since the resource allocation is performed according to the time consumption of each model unit on computing resources in the solution of the present disclosure, the task execution time of each model unit is also effectively constrained while allocating computing resources reasonably. Thus, in a multi-task environment, it is easy to allocate reasonable resources to each inference task to ensure that each inference task can be completed efficiently within a preset time period, thereby improving the execution efficiency of concurrent inference tasks effectively.

It should be noted that, in one example, the total execution time is obtained based on the total time of each network model among the plurality of network models to execute tasks; and further, for one of the plurality of network models, the total time of the network model to execute tasks may be obtained based on the actual execution time required for each model unit in the network model to execute tasks on candidate computing resources as well as the actual resource switching time corresponding to each model unit.

For example, the n-th network model among the plurality of network models is denoted as Modelₙ, the i-th model unit in the n-th network model is denoted as LG_{i,n}, and the actual execution time required for the model unit LG_{i,n} to execute the task on the candidate computing resource is denoted as t_{ac}(LG_{i,n},ST(LG_{i,n})), where ST(LG_{i,n}) represents the computing resource where the model unit LG_{i,n} executes the task; the transition-in time required for the model unit LG_{i,n} to switch from another computing resource to the candidate computing resource is denoted as τ(LG_{i,n},ST(LG_{i,n}), IN), the transition-out time required for the model unit LG_{i,n} to switch from the candidate computing resource to another computing resource is denoted as (LG_{i,n},ST(LG_{i,n}), OUT), the total time for the network model Modelₙ to execute tasks is denoted as, and then the calculation expression of the total time T_{Model}_{ₙ} for the network model Modelₙ to execute tasks is as follows:

$${T}_{{Model}_{n}} = {\sum }_{i = 0}^{len ( {Model}_{n} )} \{ {t}_{ac} ( {LG}_{i , n} , ST ( {LG}_{i , n} ) ) + {TR}_{i , n} \times τ ( {LG}_{i , n} , ST ( {LG}_{i , n} ) , OUT ) + {TR}_{i , n} \times τ ( {LG}_{i , n} , ST ( {LG}_{i , n} ) , IN ) \} \qquad Formula ( 1 )$$

$${TR}_{i , n} = \{ \begin{matrix}1 , & ST ( {LG}_{i , n} ) \neq ST ( {LG}_{i + 1 , n} ) \\ 0 , & ST ( {LG}_{i , n} ) = ST ( {LG}_{i + 1 , n} )\end{matrix} \qquad Formula ( 2 )$$

Here, len(Modelₙ) represents the number of model units in the n-th network model; TR_{i,n} indicates whether the computing resources of adjacent model units are the same; if TR_{i,n} is 1, meaning that the computing resources are not the same, then the actual resource switching time is generated at this time; if TR_{i,n} is 0, meaning that the computing resources are the same, then no actual resource switching time is generated or the actual resource switching time is zero at this time.

Further, it should be noted that the “network model” in the solution of the present disclosure may specifically be a Deep Neural Network (DNN), such as a Convolutional Neural Network (CNN), etc., or may be any other network model. The solution of the present disclosure does not impose specific restrictions on the network model; in other words, the solution of the present disclosure can be applicable to any network model.

Further, in a specific example, the processing performance of the computing resources in the multiple types of computing resources is superior to the processing performance of the CPU. Thus, in a multi-task environment, the use of the computing resources with superior performance can significantly improve the processing efficiency, and can still run efficiently when facing inference for complex model tasks, to ensure that the stable and high-speed processing efficiency can be still maintained when a plurality of inference tasks are processed in parallel, thereby laying the foundation for improving the user experience.

Further, in a specific example, the multiple types of computing resources include: at least one GPU and at least one Deep Learning Accelerator (DLA). In this way, when facing inference for complex model tasks, the execution efficiency of concurrent inference tasks is effectively improved, thereby laying the foundation for improving the user experience.

FIG. 2 is a schematic diagram of a scene comparison chart of concurrent scheduling of computing resources by a plurality of network models. As shown in the first resource invoking method in FIG. 2, each stage represents the resource usage time of a network layer in a network model. In the existing heterogeneous computing platform of CPU and GPU, even if the processing time of the network layer on the CPU is optimized, the overall throughput of the system cannot be significantly improved due to the longer time consumption on the GPU. Moreover, the inference process of the network model is essentially a sequential computing process, that is, some network layers in the network model need to be computed in a specific order. Therefore, if network layers with dependency are processed in parallel, the expected inference result cannot be obtained.

In view of this, in order to solve the above problem, the solution of the present disclosure provides a heterogeneous computing platform configured with DLA and GPU. In this case, as shown in the second resource invoking method in FIG. 2, each stage may represent the resource usage time of one or more model units in a network model, and different model units in each stage may use different computing resources. In this way, the dependency problem of network layers can be effectively solved. For example, the network layers with dependency (such as serial processing relationship) are divided into the same model unit, and this model unit contains a plurality of network layers to be processed serially. Here, since different model units can invoke different types of computing resources, it is easy to release GPU resources in time, and then it is easy for other model units to invoke GPU resources, thus improving the utilization rate of GPU resources while effectively avoiding disruption of the computation order and ensuring the correctness and efficiency of inference, and simultaneously saving the inference time and also improving the execution efficiency of inference tasks.

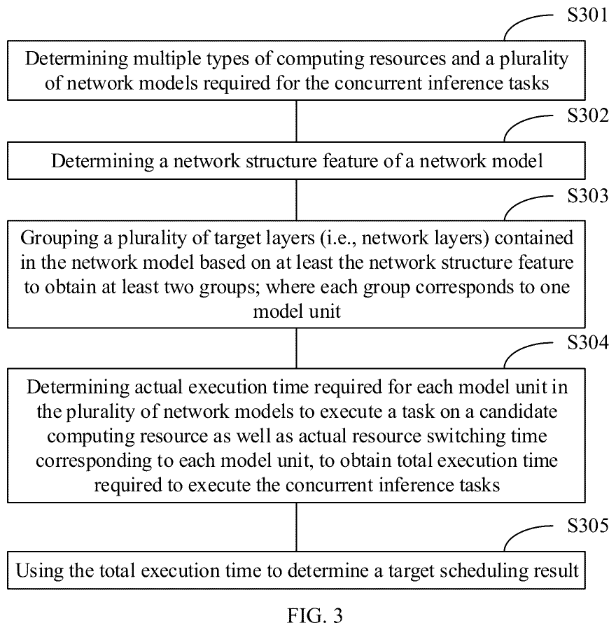

FIG. 3 is a second schematic flowchart of a method for scheduling concurrent inference tasks on a heterogeneous computing platform according to an embodiment of the present application. This method is optionally applied in electronic devices, such as personal computers, servers, server clusters and other electronic devices. It can be understood that the relevant content of the method shown in FIG. 1 and FIG. 2 described above may also be applied to this example, and the relevant content will not be repeated in this example.

Further, this method includes at least a part of the following content. As shown in FIG. 3, the method includes:

Step S301: determining multiple types of computing resources and a plurality of network models required for the concurrent inference tasks.

Here, the concurrent inference tasks represent a plurality of inference tasks to be processed in parallel, and each network model is used to execute at least one of the plurality of inference tasks.

Here, the relevant content about the concurrent inference tasks and network models, etc. can refer to the above examples, and will not be repeated here.

Step S302: determining a network structure feature of a network model.

Step S303: grouping a plurality of target layers (i.e., network layers) contained in the network model based on at least the network structure feature to obtain at least two groups; where each group corresponds to one model unit.

That is to say, for one network model among the plurality of network models, a plurality of target layers (i.e., network layers) contained in the network model may be grouped according to the network structure feature of the network model to obtain at least two groups, where each group may be considered as one model unit. In other words, the plurality of target layers contained in the network model are grouped to obtain at least two model units. For example, in one example, the target layers with a sequential relationship may be grouped into the same group, facilitating the subsequent arrangement of the target layers in the same group on the same computing resource, and thus effectively avoiding the disruption of the computing order and laying the foundation for subsequent smooth execution of concurrent tasks.

Step S304: determining actual execution time required for each model unit in the plurality of network models to execute a task on a candidate computing resource as well as actual resource switching time corresponding to each model unit, to obtain total execution time required to execute the concurrent inference tasks.

Here, the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources.

Here, the relevant content about the actual resource switching time can refer to the above examples, and will not be repeated here.

Step S305: using the total execution time to determine a target scheduling result.

Here, the target scheduling result represents at least a target computing resource to be invoked when the model unit needs to execute at least some subtasks in an inference task.

Here, the relevant content about the target scheduling result can refer to the above examples, and will not be repeated here.

Thus, the solution of the present disclosure provides a specific scheme for grouping network layers contained in a network model. That is, the plurality of target layers are merged into one “layer” (i.e., model unit) based on actual requirements, which not only optimizes the computational load but also reduces the number of memory accesses significantly; and it is easy to analyze the time consumption of model units when executing tasks at the model unit level, and then determine the computing resources required for each model unit rationally based on the time consumption. In this way, the computing resources are allocated rationally and the resource utilization rate is maximized, thereby effectively improving the overall performance and efficiency of the system.

Further, in a specific example, before grouping the target layers, the method further includes:
determining a resource switching feature required for the target layers to switch computing resources.

At this point, the plurality of target layers may be grouped in the following manner; specifically, the above-mentioned step of grouping a plurality of target layers contained in the network model based on at least the network structure feature to obtain at least two groups (for example, step S303) may specifically include:
grouping the plurality of target layers based on the network structure feature and the resource switching feature required for the target layers to switch computing resources, to obtain at least two groups.

That is to say, in the process of grouping the target layers of the network model, it is necessary to consider not only the network structure feature (such as layer type, layer parameter, batch size of processed data, etc.) but also the resource switching feature (such as whether switching is possible, etc.) to ensure the rationality and operability of the grouping result, thereby providing strong support for subsequent rational allocation of computing resources and maximizing the resource utilization rate.

Thus, the solution of the present disclosure provides a refined scheme for grouping network layers in a network model. That is, it is necessary when grouping to utilize not only the network structure feature of the network model but also the resource switching feature of the target layers, thereby making the grouping result become more reasonable and better meet the actual inference requirement, and thus providing strong support for maximizing the resource utilization rate and improving the overall performance and efficiency of the system.

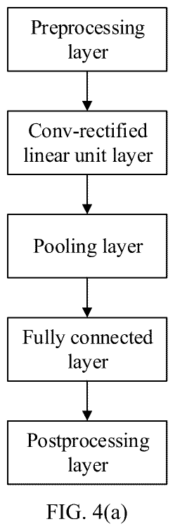

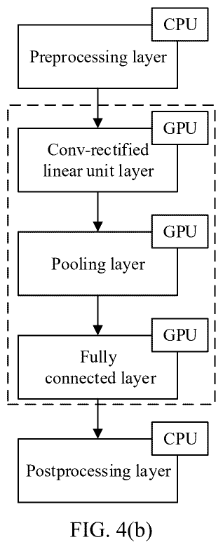

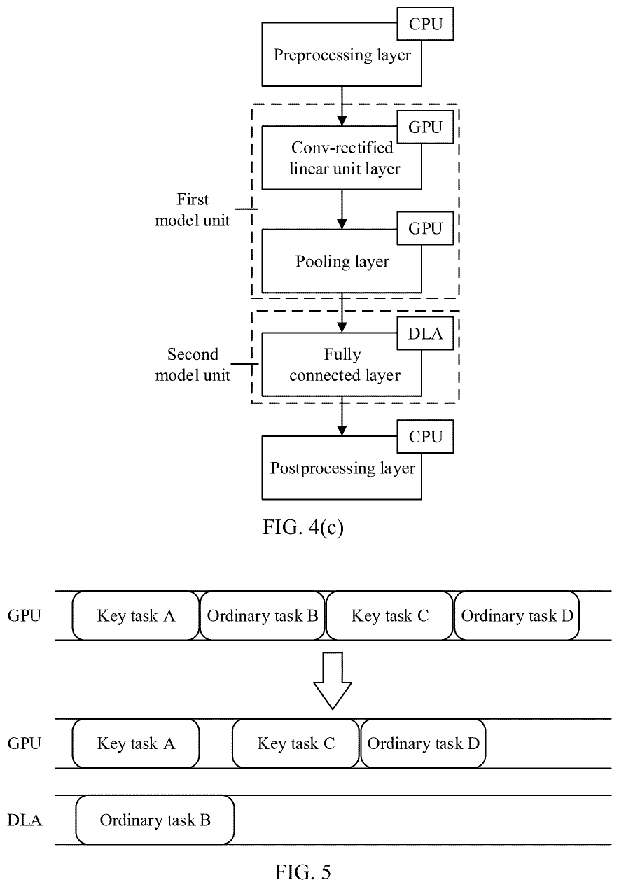

For example, taking a network model CNN as an example, as shown in FIG. 4(a), the CNN includes a preprocessing layer, a Conv-Rectified Linear Unit (Conv-ReLU) layer, a pooling layer, a fully connected layer, and a postprocessing layer in one example. As shown in FIG. 4(b), the conv-rectified linear unit, pooling layer and fully connected layer all need to invoke GPU resources. At this time, if the resource invoking method shown in FIG. 2 is used, the total time consumed by these three network layers on the GPU will be relatively long, thereby making the total processing time relatively long.

In view of this, on the heterogeneous computing platform of DLA and GPU, the solution of the present disclosure is to firstly determine the network layer that can use the DLA from a plurality of network layers contained in the CNN, and then group the network layers according to the execution order and resource types to obtain a grouping result, such as shown in FIG. 4(c). Considering that both the conv-rectified linear unit and the pooling layer need to invoke GPU resources, the conv-rectified linear unit and the pooling layer may be grouped into the same layer, for example, called the first model unit; and considering that the fully connected layer needs to invoke DLA resources, the fully connected layer may be treated as a separate layer, for example, called the second model unit.

At this point, the first model unit in the CNN may be scheduled to execute on the GPU, while the second model unit may be scheduled to execute on the DLA, thus effectively avoiding the problem of long consumed time caused by all network layers invoking GPU resources, and thereby effectively reducing the processing time of concurrent inference tasks on computing resources.

It should be noted that, in practical applications, the inference tasks are easily constrained by many factors (such as layer type, layer parameter, batch size of data to be processed, etc.) when executed on the DLA, so the above-mentioned factors also need to be considered when the plurality of network layers in the network model are grouped, thereby maximizing the resource utilization rate while ensuring that the inference tasks can be executed smoothly.

Additionally, it should be noted that the data transition overhead easily occurs between two model units utilizing different computing resources, so the current network layer and the layer following the current network layer are grouped into the same group if the network layer following the current network layer is prohibited from switching to other computing resources or if the data transition cost increases after switching in the process of grouping the network layers. In this way, the unnecessary data transition overhead can be effectively avoided.

It can be understood that grouping can be based on actual requirements of actual scenarios in practical applications. For example, the grouping results of the same network model may be different in different scenarios, or the grouping results of different network models may also be different, etc., which is not specifically limited in the solution of the present disclosure.

In a specific example, the above-mentioned step of using the total execution time to determine a target scheduling result (e.g., step S305) may specifically include:

Step S305-1: determining key tasks from a plurality of inference tasks contained in the concurrent inference tasks.

Step S305-2: determining inference start time required for each key task.

Step S305-3: minimizing the total execution time while ensuring that the inference start time required for each key task meets a preset time requirement, to determine the target scheduling result.

That is to say, in this example, it is ensured that the inference start time of each key task meets the preset time requirement, for example, the inference start time of each key task is no later than the preset time, and the total execution time is minimized under this condition to ensure that the key tasks can be processed first, thereby minimizing the end-to-end inference latency.

For example, as shown in FIG. 5, the existing method does not optimize the inference start time of each inference task among a plurality of inference tasks when scheduling the plurality of inference tasks to be executed on the GPU, so that there is no strict execution order between key tasks (such as key task A and key task C) and ordinary tasks (such as ordinary task B and ordinary task D) in the plurality of inference tasks, which may cause key tasks to fail to be completed within the preset time. In view of this, the solution of the present disclosure fully considers the inference start time of each key task in the heterogeneous computing platform of GPU and DLA, so that the key tasks on the GPU can be processed first to ensure that the key tasks can be completed within the deadline, thereby minimizing the latency of task inferences.

In this way, the solution of the present disclosure can constrain the start inference time of the key tasks in the concurrent inference tasks, so as to process the key tasks first and thus ensure that the key tasks are completed within the preset time range, thereby meeting the requirement for end-to-end inference latency on the basis of achieving the reasonable allocation of computing resources and maximizing the resource utilization rate.

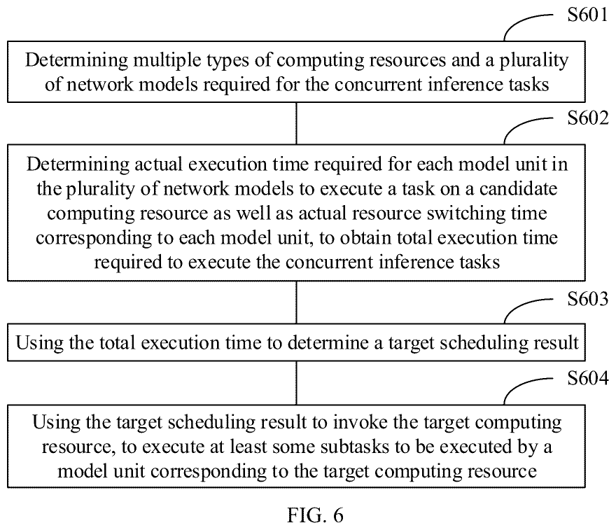

FIG. 6 is a third schematic flowchart of a method for scheduling concurrent inference tasks on a heterogeneous computing platform according to an embodiment of the present application. This method is optionally applied in electronic devices, such as personal computers, servers, server clusters and other electronic devices. It can be understood that the relevant content of the methods shown in FIG. 1 to FIG. 5 described above may also be applied to this example, and the relevant content will not be repeated in this example.

Further, this method includes at least a part of the following content. As shown in FIG. 6, this method includes:

Step S601: determining multiple types of computing resources and a plurality of network models required for the concurrent inference tasks.

Here, the concurrent inference tasks represent a plurality of inference tasks to be processed in parallel, and each network model is used to execute at least one of the plurality of inference tasks.

Here, the relevant content about the concurrent inference tasks and network models, etc. can refer to the above examples, and will not be repeated here.

Step S602: determining actual execution time required for each model unit in the plurality of network models to execute a task on a candidate computing resource as well as actual resource switching time corresponding to each model unit, to obtain total execution time required to execute the concurrent inference tasks.

Here, the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources.

Here, the relevant content about the actual resource switching time can refer to the above examples, and will not be repeated here.

Step S603: using the total execution time to determine a target scheduling result.

Here, the target scheduling result represents at least a target computing resource to be invoked when the model unit needs to execute at least some subtasks in an inference task.

Here, the relevant content about the target scheduling result can refer to the above examples, and will not be repeated here.

Step S604: using the target scheduling result to invoke the target computing resource, to execute at least some subtasks to be executed by a model unit corresponding to the target computing resource.

In this way, the solution of the present disclosure can allocate the specified target computing resource to the model unit according to the target scheduling result, so that the model unit can execute at least some subtasks on the target computing resource, thus ensuring that the concurrent inference task can be executed smoothly and stably. Moreover, in the solution of the present disclosure, the target computing resource required by each model unit is reasonably determined by analyzing the time consumption of each model unit when performing tasks on candidate computing resources, so the resource utilization rate can be maximized when the target scheduling result obtained by the solution of the present disclosure is used for resource scheduling, thereby effectively improving the overall performance and efficiency of the system, and thus effectively improving the user experience.

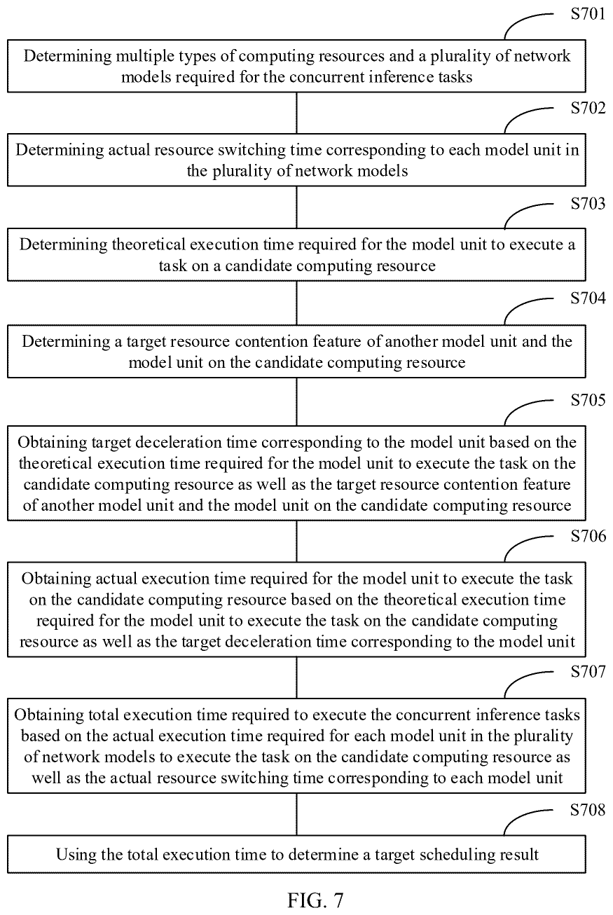

FIG. 7 is a fourth schematic flowchart of a method for scheduling concurrent inference tasks on a heterogeneous computing platform according to an embodiment of the present application. This method is optionally applied in electronic devices, such as personal computers, servers, server clusters and other electronic devices. It can be understood that the relevant content of the methods shown in FIG. 1 to FIG. 6 described above may also be applied to this example, and the relevant content will not be repeated in this example.

Further, this method includes at least a part of the following content. As shown in FIG. 7, this method includes:

Step S701: determining multiple types of computing resources and a plurality of network models required for the concurrent inference tasks.

Here, the concurrent inference tasks represent a plurality of inference tasks to be processed in parallel, and each network model is used to execute at least one of the plurality of inference tasks.

Here, the relevant content about the concurrent inference tasks and network models, etc. can refer to the above examples, and will not be repeated here.

Step S702: determining actual resource switching time corresponding to each model unit in the plurality of network models.

Here, the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources.

Here, the relevant content about the actual resource switching time can refer to the above examples, and will not be repeated here.

Step S703: determining theoretical execution time t(LG_{i,n},ST(LG_{i,n})) required for a model unit LG_{i,n} to execute a task on a candidate computing resource.

Here, the model unit LG_{i,n} represents an i-th model unit in a n-th network model among the plurality of network models; and ST(LG_{i,n}) represents the candidate computing resource where the model unit LG_{i,n} executes the task.

Step S704: determining a target resource contention feature of another model unit LG_{j,s} and the model unit LG_{i,n} on the candidate computing resource.

Here, the other model unit LG_{j,s} represents a j-th model unit in an s-th network model among the plurality of network models.

Step S705: obtaining target deceleration time corresponding to the model unit LG_{i,n} based on the theoretical execution time t(LG_{i,n},ST(LG_{i,n})) required for the model unit LG_{i,n} to execute the task on the candidate computing resource as well as the target resource contention feature of another model unit LG_{j,s} and the model unit LG_{i,n} on the candidate computing resource.

Step S706: obtaining actual execution time required for the model unit LG_{i,n} to execute the task on the candidate computing resource based on the theoretical execution time required for the model unit LG_{i,n} to execute the task on the candidate computing resource as well as the target deceleration time corresponding to the model unit LG_{i,n}.

For example, in one example, the sum of the theoretical execution time required for the model unit LG_{i,n} to execute the task on the candidate computing resource and the target deceleration time corresponding to the model unit LG_{i,n} is taken as the actual execution time required for the model unit LG_{i,n} to execute the task on the candidate computing resource.

For example, in one example, the target resource contention feature of another model unit LG_{j,s} and the model unit LG_{i,n} on the candidate computing resource is denoted as C_{LG}_{_{i,n}}_{,ST(LG}_{_{i,n}}_{),LG}_{_{j,s}}; and at this time, the target deceleration time of the model unit LG_{i,n} caused by resource contention with another model unit LG_{j,s} may be expressed as: t(LG_{i,n},ST(LG_{i,n}))·C_{LG}_{_{i,n}}_{,ST(LG}_{_{i,n}}_{),LG}_{_{j,s}}.

Further, the actual execution time required for the model unit LG_{i,n} to execute the task on the candidate computing resource is denoted as t_{ac}(LG_{i,n},ST(LG_{i,n})), and then the calculation expression of the actual execution time t_{ac}(LG_{i,n},ST(LG_{i,n})) required for the model unit LG_{i,n} to execute the task on the candidate computing resource caused by resource contention with another model units LG_{j,s} may be specifically as follows:

$${t}_{ac} ( L {G}_{i , n} , ST ( {LG}_{i , n} ) ) = t ( {LG}_{i , n} , ST ( {LG}_{i , n} ) ) + t ( {LG}_{i , n} , ST ( {LG}_{i , n} ) ) \cdot {C}_{{LG}_{i , n} , ST ( {LG}_{i , n} ) , {LG}_{j , s}} \qquad Formula ( 3 )$$

Step S707: obtaining total execution time required to execute the concurrent inference tasks based on the actual execution time required for each model unit in the plurality of network models to execute the task on the candidate computing resource as well as the actual resource switching time corresponding to each model unit.

Step S708: using the total execution time to determine a target scheduling result.

Here, the target scheduling result represents at least a target computing resource to be invoked when the model unit needs to execute at least some subtasks in an inference task.

Here, the relevant content about the target scheduling result can refer to the above examples, and will not be repeated here.

In this way, the solution of the present disclosure can calculate the target deceleration time of the model unit due to resource contention, and thus obtain the actual execution time required for the model unit to execute the task on the candidate computing resource. The above process fully considers the time delay caused by resource contention when calculating the actual execution time of the model unit, thus improving the accuracy of the actual execution time of the model unit effectively, ensuring the accuracy and reliability of the total execution time, providing data support for rationally allocating the computing resources and thus maximizing the resource utilization rate, and thereby providing strong support for improving the overall performance and efficiency of the system.

Further, in a specific example, the target resource contention feature may be obtained in the following manner; specifically, the above-mentioned step of determining a target resource contention feature of another model unit LG_{j,s} and the model unit LG_{i,n} on the candidate computing resource (for example, step S704) may specifically include:

Step S704-1: determining theoretical contention time when both another model unit LG_{j,s} and the model unit LG_{i,n} execute tasks on the candidate computing resource.

For example, in one example, if another model unit LG_{j,s} performs resource contention with the model unit LG_{i,n} on the candidate computing resource, then the execution period of the other model unit LG_{j,s} on the candidate computing resource has an overlap part with the execution period of the model unit LG_{i,n} on the candidate computing resource, where the overlap duration represented by the overlap part can be directly used as the theoretical contention time.

Further, if the theoretical contention time between another model unit LG_{j,s} and the model unit LG_{i,n} is denoted as I(LG_{i,n},LG_{j,s}), then the calculation expression of the theoretical contention time I(LG_{i,n},LG_{j,s}) is as follows:

$$I ( {LG}_{i , n} , {LG}_{j , s} ) = \{ \begin{matrix}et ( i , n ) - st ( j , s ) , & st ( i , n ) \leq st ( j , s ) \leq et ( i , n ) \leq et ( j , s ) \\ et ( j , s ) - st ( j , s ) & st ( i , n ) \leq st ( j , s ) \leq et ( j , s ) \leq et ( i , n ) \\ et ( j , s ) - st ( i , n ) & st ( j , s ) \leq st ( i , n ) \leq et ( j , s ) \leq et ( i , n ) \\ et ( i , n ) - st ( i , n ) & st ( j , s ) \leq st ( i , n ) \leq et ( i , n ) \leq et ( j , s ) \\ et ( i , n ) - st ( i , n ) & others\end{matrix} \qquad Formula ( 4 )$$

Here, st(i,n) and et(i,n) represent the start execution time and end execution time of the model unit LG_{i,n} on the candidate computing resource, respectively; st(j,s) and et(j,s) represent the start execution time and end execution time of the model unit LG_{j,s} on the candidate computing resource, respectively.

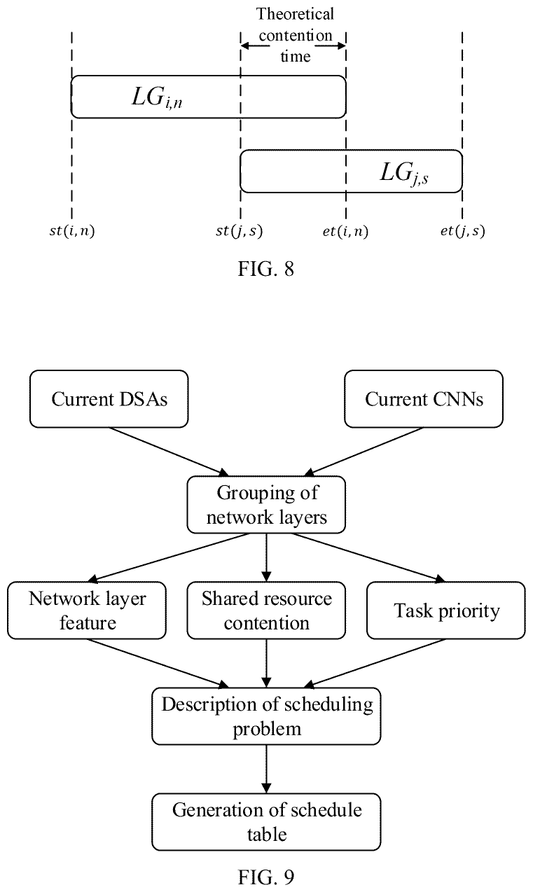

For example, as shown in FIG. 8, the relationship between the start execution time st(i,n) and end execution time et(i,n) of the model unit LG_{i,n} on the candidate computing resource and the start execution time st(j,s) and end execution time et(j,s) of the model unit LG_{j,s} on the candidate computing resource is st(i,n)≤st(j,s)≤et(i,n)≤et(j,s). Therefore, the theoretical contention time I(LG_{i,n},LG_{j,s})=et(i,n)−st(j,s).

Step S704-2: determining a degree of time deceleration caused by resource contention between the other model unit LG_{j,s} and the model unit LG_{i,n} on the candidate computing resource.

Step S704-3: obtaining the target resource contention feature based on at least the theoretical contention time when both the other model unit LG_{j,s} and the model unit LG_{i,n} execute tasks on the candidate computing resource as well as the degree of time deceleration corresponding to the other model unit LG_{j,s} and the model unit LG_{i,n} on the candidate computing resource.

In this way, the solution of the present disclosure provides a specific scheme for obtaining the target resource contention feature. This scheme quantifies the degree of resource contention between model units to obtain the target resource contention feature, providing strong support for accurately calculating the actual execution time of model units on candidate computing resources in the subsequent process.

Further, in a specific example, the above-mentioned step of determining a degree of time deceleration caused by resource contention between the other model unit LG_{j,s} and the model unit LG_{i,n} on the candidate computing resource (for example, step S704-2) may specifically include:

Step S704-2-1: determining the number of all other model units having resource contention with the model unit LG_{i,n} on the candidate computational resource.

Step S704-2-2: determining a bandwidth contention feature of the other model unit LG_{j,s} and the model unit LG_{i,n} on the candidate computing resource.

Step S704-2-3: obtaining the degree of time deceleration caused by resource contention between the other model unit LG_{j,s} and the model unit LG_{i,n} on the candidate computing resource based on the number of all other model units having resource contention with the model unit LG_{i,n} on the candidate computational resource as well as the bandwidth contention feature of the other model unit LG_{j,s} and the model unit LG_{i,n} on the candidate computing resource.

Continue with the example of another model unit LG_{j,s} and the model unit LG_{i,n} that perform resource contention in FIG. 8. At this point, the theoretical contention time when both another model unit LG_{j,s} and the model unit LG_{i,n} execute tasks on the candidate computing resource is denoted as I(LG_{i,n},LG_{j,s}), the set of other model units performing resource contention with the model unit LG_{i,n} is denoted as LG_{R}, the bandwidth contention feature of another model unit LG_{j,s} and the model unit LG_{i,n} on the candidate computing resource is denoted as count_model(LG_{i,n},LG_{j,s}), and then the degree of time deceleration caused by resource contention between another model unit LG_{j,s} and the model unit LG_{i,n} on the candidate computing resource may be specifically as follows:

$$\frac{count\_model ( L {G}_{i , n} , {LG}_{j , s} )}{len ( {LG}_{R} )} \qquad Formula ( 5 )$$

Here, len(LG_{R}) represents the number of all other model units performing resource contention with the model unit LG_{i,n}.

Further, in a specific example, the target resource contention feature of another model unit LG_{j,s} and the model unit LG_{i,n} on the candidate computing resource is C_{LG}_{_{i,n}}_{,ST(LG}_{_{i,n}}_{),LG}_{_{j,s}}, and may be specifically expressed as:

$${C}_{{LG}_{i , n} ST ( {LG}_{i , n} ) {LG}_{j , s}} = \frac{I ( {LG}_{i , n} , {LG}_{j , s} ) \cdot count\_model ( {LG}_{i , n} , {LG}_{j , s} )}{len ( {LG}_{R} )} \qquad Formula ( 6 )$$

Further, in one example, the target deceleration time of the model unit LG_{i,n} caused by resource contention with another model unit LG_{j,s} may be expressed as:

$$t ( {LG}_{i , n} , ST ( {LG}_{i , n} ) ) \cdot \frac{I ( {LG}_{i , n} , {LG}_{j , s} ) \cdot count\_model ( {LG}_{i , n} , {LG}_{j , s} )}{len ( {LG}_{R} )} \qquad Formula ( 7 )$$

In this way, the solution of the present disclosure provides a specific scheme for obtaining the degree of time deceleration. This scheme is simple, practical and highly interpretable, thereby providing strong support for subsequent calculation of the actual execution time of the model unit on the candidate computing resource, and thus laying the foundation for subsequent calculation of the total execution time and the rational allocation of computing resources.

The solution of the present disclosure will be further described in detail below with reference to specific examples; and the solution of the present disclosure provides a method for scheduling concurrent inference tasks based on a heterogeneous computing platform of DLA and GPU. Specifically, as shown in FIG. 9, on the heterogeneous computing platform equipped with Data Streaming Accelerators (DSAs) (such as DLAs) and GPU, firstly all computing resources available for concurrent inference tasks (for example, denoted as DSAs) and all CNNs available for concurrent inference tasks (for example, denoted as CNNs) are required; secondly there is a need to determine the priority of each inference task in the concurrent inference tasks to distinguish between key tasks and ordinary tasks; and the network layers in a network model are grouped according to the characteristics of the network layers to obtain at least two model units. Here, when the computing resources are allocated to the model units, the network layer features, shared resource contention, resource switching cost, task priorities and others may be considered. Based on this, the above resource scheduling problem can be transformed into a constrained optimization problem, with the goal of maximizing the resource utilization rate, minimizing the task latency, and ensuring that the key tasks can be completed within the deadline. Finally, the mathematical language is used to describe the scheduling problem and solve for a scheduling timetable (corresponding to the target scheduling result mentioned above), so as to allocate the specified computing resources to all model units, so that the resource utilization rate can be effectively improved, thereby increasing the overall throughput of the system.

Here, taking multiple CNNs as an example, a scheduling timetable is determined for all model units in all CNNs on the heterogeneous computing platform, that is, a mapping relationship between all model units in the multiple CNNs and accelerators (corresponding to the computing resources mentioned above) is solved. Table I shows the variables and symbols that may be used in the solution of the present disclosure.

TABLE 1
Explanation of Symbols and Variables

| Symbol | Explanation |
|---|---|
| {CNN} | Network model set of multiple CNNs |
| CNNₙ | n-th CNN among given multiple CNNs |
| LG_{i, n} | i-th model unit of n-th CNN in set {CNN} |
| len(CNNₙ) | Number of model units in n-th CNN |
| Aₐ | a-th accelerator in given accelerator set (including GPU and DLA) A |
| ST(LG_{i, n}) | Scheduling mapping of LG_{i, n} on Aₐ, that is, accelerator where LG_{i, n} resides |
| t(LG_{i, n}, Aₐ) | Theoretical execution time required for LG_{i, n} to execute task on Aₐ |
| st(i, n) | Start execution time of LG_{i, n} |
| et(i, n) | End execution time of LG_{i, n} |
| τ(LG_{i, n}, ST(LG_{i, n}), OUT) | Transition-out time required to switch from ST(LG_{i, n}) to another accelerator |
| | after executing LG_{i, n} |
| τ(LG_{i, n}, ST(LG_{i, n}), IN) | Transition-in time required to switch to ST(LG_{i, n}) before executing LG_{i, n} |
| TR_{i, n} | Boolean variable indicating whether to set transition after model unit LG_{i, n} |
| T(LG, ST(LG))ₙ | Total execution time of all model units of n-th CNN |
| C_{LG}_{_{i, n}}_{, ST(LG}_{_{i, n}}_{), LG}_{_{j, s}} | Resource contention feature of model unit LG_{i, n} and another model unit LG_{j, s} on |
| | accelerator |
| LG_{R} | Set of all model units performing resource contention with model unit LG_{i, n} on |
| | accelerator |
| I(LG_{i, n}, LG_{j, s}) | Overlap time between model unit LG_{i, n} and model unit LG_{j, s} on same accelerator |
| Int | Set of overlap times between model unit LG_{i, n} and other model units |
| DLₙ | Deadline for n-th CNN to complete task, infinity for ordinary task |

Further, the algorithm of the solution of the present disclosure aims at finding a scheduling result (including the start execution time of the task and the accelerator to be invoked by the model unit) for each model unit in multiple CNNs.

Specifically, the algorithm of the solution of the present disclosure includes:
defining a scheduling function between model unit LG_{i,n} and accelerator Aₐ as:

$$ST ( {LG}_{i , n} ) = {A}_{a} \qquad Formula ( 8 )$$

$$\{ \begin{matrix}1 \leq i \leq len ( {CNN}_{n} ) \\ 1 \leq n \leq len ( \{ CNN \} ) \\ 1 \leq a \leq len ( A )\end{matrix}$$

The goal is to obtain Aₐ to which LG_{i,n} is mapped.

Further, the total execution time is determined. Specifically, the total execution time of the n-th CNN includes the actual execution time of each model unit on an accelerator, the transition-out time required to switch from the current accelerator to another accelerator after completing the task, and the transition-in time required for the model unit to switch from another accelerator to the current accelerator. At this point, if the total execution time of the n-th CNN is denoted as T(LG,ST(LG→A))ₙ, then the total execution time T(LG,ST(LG→A))ₙ may be expressed by the following formula:

$${T ( LG , ST ( LG \to A ) )}_{n} = {\sum }_{i = 0}^{len ( {CNN}_{n} )} \{ {t}_{ac} ( {LG}_{i , n} , ST ( {LG}_{i , n} ) ) + {TR}_{i , n} \times τ ( {LG}_{i , n} , ST ( {LG}_{i , n} ) , OUT ) + {TR}_{i , n} \times τ ( {LG}_{i , n} , ST ( {LG}_{i , n} ) , IN ) \} \qquad Formula ( 9 )$$

Here, t_{ac}(LG_{i,n},ST(LG_{i,n})) represents the actual execution time of the model unit LG_{i,n} on the accelerator (i.e., ST(LG_{i,n})).

Further, the decision for accelerator transition of the model unit may be encoded into the above Formula (9) using the following Formula (10) (i.e., Boolean function). Specifically, the value of the Boolean function may be obtained based on whether the accelerators of adjacent model units LG_{i,n} and LG_{i+1,n} are the same; if different accelerators are allocated, the actual resource switching time t will be generated; otherwise, no actual resource switching time will be generated. Here, the specific expression of the Boolean function is as follows:

$$T {R}_{i , n} = \{ \begin{matrix}0 , ST ( {LG}_{i , n} ) \neq ST ( {LG}_{i + 1 , n} ) \\ 1 , ST ( {LG}_{i , n} ) = ST ( {LG}_{i + 1 , n} )\end{matrix} \qquad Formula ( 10 )$$

Further, formulas (11) and (12) are used to calculate the start execution time (denoted as st(i,n)) and end execution time (denoted as et(i,n)) of the model unit LG_{i,n}, respectively. The specific formulas are as follows:

$$st ( i , n ) = T ( {LG}_{= 0 \to i - 1 , n} , ST ( {LG}_{= 0 \to i - 1 , n} ) ) \qquad Formula ( 11 )$$

Here, the start execution time of the model unit LG_{i,n} is obtained based on the actual execution time of the first i−1 model units.

$$et ( i , n ) = st ( i , n ) + {t}_{ac} ( {LG}_{i , n} , ST ( {LG}_{i , n} ) ) \qquad Formula ( 12 )$$

$$1 \leq i \leq len ( {CNN}_{n} ) , 1 \leq n \leq len ( \{ CNN \} )$$

Here, len({CNN}) represents the number of CNNs, and len(CNNₙ) represents the number of model units in the n-th CNN.

Further, the actual execution time t_{ac}(LG_{i,n},ST(LG_{i,n})) of the model unit LG_{i,n} on the accelerator (i.e., ST(LG_{i,n})) is obtained based on the theoretical execution time (i.e., t(LG_{i,n},ST(LG_{i,n}))) of the model unit LG_{i,n} on the accelerator as well as the deceleration ratio between the model unit LG_{i,n} and another model unit LG_{j,s} that perform resource contention on the accelerator. At this point, due to the resource contention between another model unit LG_{j,s} and the model unit LG_{i,n}, the actual execution time t_{ac}(LG_{i,n},ST(LG_{i,n})) may be expressed by the following formula:

$${t}_{ac} ( {LG}_{i , n} , ST ( {LG}_{i , n} ) ) = j ( {LG}_{i , n} , ST ( {LG}_{i , n} ) ) + t ( {LG}_{i , n} , ST ( {LG}_{i , n} ) ) \cdot {C}_{{LG}_{i , n} ST ( {LG}_{i , n} ) , {LG}_{j , s}} \qquad Formula ( 13 )$$

Further, C_{LG}_{_{i,n}}_{,ST(LG}_{_{i,n}}_{),LG}_{_{j,s}} may be specifically understood as the resource contention feature that another model unit LG_{j,s} performs resource contention with the model unit LG_{i,n}, where C represents the resource contention function. Specific details of obtaining C_{LG}_{_{i,n}}_{,ST(LG}_{_{i,n}}_{),LG}_{_{j,s}} will be given below.

Specifically, as shown in Formula (14), the resource contention feature C_{LG}_{_{i,n}}_{,ST(LG}_{_{i,n}}_{),LG}_{_{j,s}} is obtained based on the overlap time (denoted as I(LG_{i,n},LG_{j,s}) or simply I(i,j)) between the model unit LG_{i,n} and another model units LG_{j,s} on the accelerator as well as the degree of time deceleration caused by resource contention between the model unit LG_{i,n} and another model unit LG_{j,s} on the accelerator. Specifically, the resource contention feature C_{LG}_{_{i,n}}_{,ST(LG}_{_{i,n}}_{),LG}_{_{j,s}} may be expressed by the following formula:

$${C}_{{LG}_{i , n} ST ( {LG}_{i , n} ) {LG}_{j , s}} = \frac{I ( {LG}_{i , n} , {LG}_{j , s} ) \cdot count\_model ( {LG}_{i , n} , {LG}_{j , s} )}{len ( {LG}_{R} )} \qquad Formula ( 14 )$$

Further, the total resource contention feature C_{LG}_{_{i,n}}_{,ST(LG}_{_{i,n}}_{),LG}_{_{R}} that the model unit LG_{i,n} performs resource contention with all other model units may be specifically expressed as:

$${C}_{{LG}_{i , n} ST ( {LG}_{i , n} ) {LG}_{R}} = {\sum }_{I ( i , j ) ∈ Int} \frac{I ( {LG}_{i , n} , {LG}_{j , s} ) \cdot count\_model ( {LG}_{i , n} , {LG}_{j , s} )}{len ( {LG}_{R} )} \qquad Formula ( 15 )$$

$$1 \leq j \leq len ( {CNN}_{n} ) , 1 \leq n \leq len ( \{ CNN \} ) , {LG}_{j , s} ∈ {LG}_{R}$$

$$Int ⋂ [ st ( i , n ) , et ( i , n ) ] \neq 0 , Int ⋂ [ st ( j , s ) , et ( j , s ) ] \neq 0$$

Here, Int represents the set of all overlap times of the model unit LG_{i,n} on the accelerator; LG_{R} represents the set of all other model units performing resource contention with the model unit LG_{i,n} on the accelerator, for example, LG_{R} includes LG_{j,s}, LG_{k,m}, etc.; len(LG_{R}) represents the number of other model units performing resource contention with the model unit LG_{i,n} on the accelerator; and count_model(⋅) represents the bandwidth contention function, which can represent the bandwidth contention feature, such as the relationship between the bandwidth requirement of the model unit LG_{i,n} and the cumulative external bandwidth requirement of other model units having overlap time with the model unit.

Further, I(LG_{i,n},LG_{j,s}) in the above Formula (14) or Formula (15) may be obtained according to the start execution time and end execution time of the model unit on the accelerator. I(LG_{i,n},LG_{j,s}) may be expressed by the following formula:

$$I ( {LG}_{i , n} , {LG}_{j , s} ) = \{ \begin{matrix}et ( i , n ) - st ( j , s ) , & st ( i , n ) \leq st ( j , s ) \leq et ( i , n ) \leq et ( j , s ) \\ et ( j , s ) - st ( j , s ) & st ( i , n ) \leq st ( j , s ) \leq et ( j , s ) \leq et ( i , n ) \\ et ( j , s ) - st ( i , n ) & st ( j , s ) \leq st ( i , n ) \leq et ( j , s ) \leq et ( i , n ) \\ et ( i , n ) - st ( i , n ) & st ( j , s ) \leq st ( i , n ) \leq et ( i , n ) \leq et ( j , s ) \\ et ( i , n ) - st ( i , n ) & others\end{matrix} \qquad Formula ( 16 )$$

Here, if there is no resource contention between the model unit LG_{i,n} and the model unit LG_{j,s}, then the above Formula (16) only returns the execution time (i.e., et(i,n)−st(i,n)) of this layer, so that the result in Formula (14) is 0, indicating at this time that there is no deceleration effect when the model unit LG_{i,n} runs independently in Formula (9) and Formula (13).

Further, it is ensured according to Formula (17) that the resource utilization rate is maximized to improve the overall throughput of the system, and that the inference time of any key task in the concurrent inference tasks does not exceed the deadline of the key task. The specific formula is as follows:

$$max {\sum }_{n = 1}^{len ( \{ CNN \} )} \frac{1}{{T ( LG , ST ( LG ) )}_{n}} \qquad Formula ( 17 )$$

$${T ( LG , ST ( LG ) )}_{n} \leq {DL}_{n}$$

At this point, at least the mapping relationship between model units and accelerators is obtained (that is, the target scheduling result is obtained) by solving Formula (8).

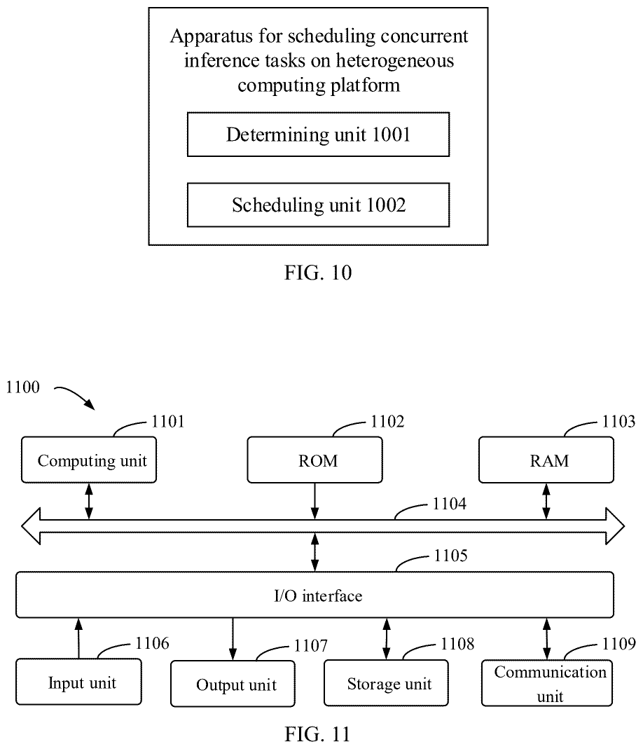

The solution of the present disclosure further provides an apparatus for scheduling concurrent inference tasks on a heterogeneous computing platform, as shown in FIG. 10, including:
a determining unit 1001 configured to determine multiple types of computing resources and a plurality of network models required for the concurrent inference tasks, where the concurrent inference tasks represent a plurality of inference tasks to be processed in parallel, and each network model is used to execute at least one of the plurality of inference tasks; and determine actual execution time required for each model unit in the plurality of network models to execute a task on a candidate computing resource as well as actual resource switching time corresponding to each model unit, to obtain total execution time required to execute the concurrent inference tasks; where the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources; and
a scheduling unit 1002 configured to use the total execution time to determine a target scheduling result, where the target scheduling result represents at least a target computing resource to be invoked when the model unit needs to execute at least some subtasks in an inference task.

In a specific example of the solution of the present disclosure, the scheduling unit is further configured to:
use the target scheduling result to invoke the target computing resource, to execute at least some subtasks to be executed by a model unit corresponding to the target computing resource.

In a specific example of the solution of the present disclosure, processing performance of a computing resource among the multiple types of computing resources is superior to processing performance of a CPU.

In a specific example of the solution of the present disclosure, the multiple types of computing resources include: at least one GPU and at least one deep learning accelerator.

In a specific example of the solution of the present disclosure, the determining unit is specifically configured to:
determine theoretical execution time t(LG_{i,n},ST(LG_{i,n})) required for a model unit LG_{i,n} to execute a task on a candidate computing resource; where the model unit LG_{i,n} represents an i-th model unit in a n-th network model among the plurality of network models; and ST(LG_{i,n}) represents the candidate computing resource where the model unit LG_{i,n} executes the task;
determine a target resource contention feature of another model unit LG_{j,s} and the model unit LG_{i,n} on the candidate computing resource; where the other model unit LG_{j,s} represents a j-th model unit in an s-th network model among the plurality of network models;
obtain target deceleration time corresponding to the model unit LG_{i,n} based on the theoretical execution time t(LG_{i,n},ST(LG_{i,n})) required for the model unit LG_{i,n} to execute the task on the candidate computing resource as well as the target resource contention feature of another model unit LG_{j,s} and the model unit LG_{i,n} on the candidate computing resource; and
obtain actual execution time required for the model unit LG_{i,n} to execute the task on the candidate computing resource based on the theoretical execution time required for the model unit LG_{i,n} to execute the task on the candidate computing resource as well as the target deceleration time corresponding to the model unit LG_{i,n}.

In a specific example of the solution of the present disclosure, the determining unit is specifically configured to:
determine theoretical contention time when both the other model unit LG_{j,s} and the model unit LG_{i,n} execute tasks on the candidate computing resource;
determine a degree of time deceleration caused by resource contention between the other model unit LG_{j,s} and the model unit LG_{i,n} on the candidate computing resource; and
obtain the target resource contention feature based on at least the theoretical contention time when both the other model unit LG_{j,s} and the model unit LG_{i,n} execute tasks on the candidate computing resource as well as the degree of time deceleration corresponding to the other model unit LG_{j,s} and the model unit LG_{i,n} on the candidate computing resource.

In a specific example of the solution of the present disclosure, the determining unit is specifically configured to:
determine the number of all other model units having resource contention with the model unit LG_{i,n} on the candidate computational resource;
determine a bandwidth contention feature of the other model unit LG_{j,s} and the model unit LG_{i,n} on the candidate computing resource; and
obtain the degree of time deceleration caused by resource contention between the other model unit LG_{j,s} and the model unit LG_{i,n} on the candidate computing resource based on the number of all other model units having resource contention with the model unit LG_{i,n} on the candidate computational resource as well as the bandwidth contention feature of the other model unit LG_{j,s} and the model unit LG_{i,n} on the candidate computing resource.

In a specific example of the solution of the present disclosure, the determining unit is further configured to:
determine a network structure feature of a network model; and
group a plurality of target layers contained in the network model based on at least the network structure feature to obtain at least two groups; where each group corresponds to one model unit.

In a specific example of the solution of the present disclosure, the determining unit is specifically configured to:
determine a resource switching feature required for the target layers to switch computing resources; and
group the plurality of target layers based on the network structure feature and the resource switching feature required for the target layers to switch computing resources, to obtain at least two groups.

In a specific example of the solution of the present disclosure, the scheduling unit is further configured to:
determine key tasks from a plurality of inference tasks contained in the concurrent inference tasks;
determine inference start time required for each key task; and
minimize the total execution time while ensuring that the inference start time required for each key task meets a preset time requirement, to determine the target scheduling result.

For the description of specific functions and examples of the units of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 11 shows a schematic block diagram of an exemplary electronic device 1100 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 11, the device 1100 includes a computing unit 1101 that may perform various appropriate actions and processes according to a computer program stored in a Read-Only Memory (ROM) 1102 or a computer program loaded from a storage unit 1108 into a Random Access Memory (RAM) 1103. Various programs and data required for an operation of device 1100 may also be stored in the RAM 1103. The computing unit 1101, the ROM 1102 and the RAM 1103 are connected to each other through a bus 1104. The input/output (I/O) interface 1105 is also connected to the bus 1104.

A plurality of components in the device 1100 are connected to the I/O interface 1105, and include an input unit 1106 such as a keyboard, a mouse, or the like; an output unit 1107 such as various types of displays, speakers, or the like; the storage unit 1108 such as a magnetic disk, an optical disk, or the like; and a communication unit 1109 such as a network card, a modem, a wireless communication transceiver, or the like. The communication unit 1109 allows the device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1101 performs various methods and processes described above, such as the method for scheduling concurrent inference tasks on the heterogeneous computing platform. For example, in some implementations, the method for scheduling concurrent inference tasks on the heterogeneous computing platform may be implemented as a computer software program tangibly contained in a computer-readable medium, such as the storage unit 1108. In some implementations, a part or all of the computer program may be loaded and/or installed on the device 1100 via the ROM 1102 and/or the communication unit 1109. When the computer program is loaded into the RAM 1103 and executed by the computing unit 1101, one or more steps of the method for scheduling concurrent inference tasks on the heterogeneous computing platform described above may be performed. Alternatively, in other implementations, the computing unit 1101 may be configured to perform the method for scheduling concurrent inference tasks on the heterogeneous computing platform by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for scheduling concurrent inference tasks, comprising:
determining multiple types of computing resources and a plurality of network models required for the concurrent inference tasks, wherein the concurrent inference tasks represent a plurality of inference tasks to be processed in parallel, and each network model is used to execute at least one of the plurality of inference tasks;
determining actual execution time required for each model unit in the plurality of network models to execute a task on a candidate computing resource as well as actual resource switching time corresponding to each model unit, to obtain total execution time required to execute the concurrent inference tasks; wherein the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources; and
using the total execution time to determine a target scheduling result, wherein the target scheduling result represents at least a target computing resource to be invoked, in a case of the model unit needs to execute at least some subtasks in an inference task.

2. The method of claim 1, further comprising:
using the target scheduling result to invoke the target computing resource, to execute at least some subtasks to be executed by a model unit corresponding to the target computing resource.

3. The method of claim 1, wherein processing performance of a computing resource among the multiple types of computing resources is superior to processing performance of a CPU.

4. The method of claim 3, wherein the multiple types of computing resources comprise: at least one GPU and at least one deep learning accelerator.

5. The method of claim 1, wherein the determining actual execution time required for each model unit in the plurality of network models to execute a task on a candidate computing resource, comprises:
determining theoretical execution time t(LG_{i,n},ST(LG_{i,n})) required for a model unit LG_{i,n} to execute a task on a candidate computing resource; wherein the model unit LG_{i,n} represents an i-th model unit in a n-th network model among the plurality of network models; and ST(LG_{i,n}) represents the candidate computing resource where the model unit LG_{i,n} executes the task;
determining a target resource contention feature of another model unit LG_{j,s} and the model unit LG_{i,n} on the candidate computing resource; wherein the other model unit LG_{j,s} represents a j-th model unit in an s-th network model among the plurality of network models;
obtaining target deceleration time corresponding to the model unit LG_{i,n} based on the theoretical execution time t(LG_{i,n},ST(LG_{i,n})) required for the model unit LG_{i,n} to execute the task on the candidate computing resource as well as the target resource contention feature of another model unit LG_{j,s} and the model unit LG_{i,n} on the candidate computing resource; and
obtaining actual execution time required for the model unit LG_{i,n} to execute the task on the candidate computing resource based on the theoretical execution time required for the model unit LG_{i,n} to execute the task on the candidate computing resource as well as the target deceleration time corresponding to the model unit LG_{i,n}.

6. The method of claim 5, wherein the determining a target resource contention feature of another model unit LG_{j,s} and the model unit LG_{i,n} on the candidate computing resource, comprises:
determining theoretical contention time, in a case of both the other model unit LG_{j,s} and the model unit LG_{i,n} execute tasks on the candidate computing resource;
determining a degree of time deceleration caused by resource contention between the other model unit LG_{j,s} and the model unit LG_{i,n} on the candidate computing resource; and
obtaining the target resource contention feature based on at least the theoretical contention time, in a case of both the other model unit LG_{j,s} and the model unit LG_{i,n} execute tasks on the candidate computing resource as well as the degree of time deceleration corresponding to the other model unit LG_{j,s} and the model unit LG_{i,n} on the candidate computing resource.

7. The method of claim 6, wherein the determining a degree of time deceleration caused by resource contention between the other model unit LG_{j,s} and the model unit LG_{i,n} on the candidate computing resource, comprises:
determining the number of all other model units having resource contention with the model unit LG_{i,n} on the candidate computational resource;
determining a bandwidth contention feature of the other model unit LG_{j,s} and the model unit LG_{i,n} on the candidate computing resource; and
obtaining the degree of time deceleration caused by resource contention between the other model unit LG_{j,s} and the model unit LG_{i,n} on the candidate computing resource based on the number of all other model units having resource contention with the model unit LG_{i,n} on the candidate computational resource as well as the bandwidth contention feature of the other model unit LG_{j,s} and the model unit LG_{i,n} on the candidate computing resource.

8. The method of claim 1, further comprising:
determining a network structure feature of a network model; and
grouping a plurality of target layers contained in the network model based on at least the network structure feature to obtain at least two groups; wherein each group corresponds to one model unit.

9. The method of claim 8, further comprising:
determining a resource switching feature required for the target layers to switch computing resources;
wherein the grouping a plurality of target layers contained in the network model based on at least the network structure feature to obtain at least two groups, comprises:
grouping the plurality of target layers based on the network structure feature and the resource switching feature required for the target layers to switch computing resources, to obtain at least two groups.

10. The method of claim 8, wherein the using the total execution time to determine a target scheduling result, comprises:
determining key tasks from a plurality of inference tasks contained in the concurrent inference tasks;
determining inference start time required for each key task; and
minimizing the total execution time while ensuring that the inference start time required for each key task meets a preset time requirement, to determine the target scheduling result.

11. An electronic device, comprising:
at least one processor; and
a memory connected in communication with the at least one processor;
wherein the memory stores an instruction executable by the at least one processor, and the instruction, when executed by the at least one processor, enables the at least one processor to execute:
determining multiple types of computing resources and a plurality of network models required for the concurrent inference tasks, wherein the concurrent inference tasks represent a plurality of inference tasks to be processed in parallel, and each network model is used to execute at least one of the plurality of inference tasks;
determining actual execution time required for each model unit in the plurality of network models to execute a task on a candidate computing resource as well as actual resource switching time corresponding to each model unit, to obtain total execution time required to execute the concurrent inference tasks; wherein the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources; and
using the total execution time to determine a target scheduling result, wherein the target scheduling result represents at least a target computing resource to be invoked, in a case of the model unit needs to execute at least some subtasks in an inference task.

12. The electronic device of claim 11, the instruction, when executed by the at least one processor, enables the at least one processor to further execute:
using the target scheduling result to invoke the target computing resource, to execute at least some subtasks to be executed by a model unit corresponding to the target computing resource.

13. The electronic device of claim 11, wherein processing performance of a computing resource among the multiple types of computing resources is superior to processing performance of a CPU.

14. The electronic device of claim 13, wherein the multiple types of computing resources comprise: at least one GPU and at least one deep learning accelerator.

15. The electronic device of claim 11, wherein the determining actual execution time required for each model unit in the plurality of network models to execute a task on a candidate computing resource, comprises:
determining theoretical execution time t(LG_{i,n},ST(LG_{i,n})) required for a model unit LG_{i,n} to execute a task on a candidate computing resource; wherein the model unit LG_{i,n} represents an i-th model unit in a n-th network model among the plurality of network models; and ST(LG_{i,n}) represents the candidate computing resource where the model unit LG_{i,n} executes the task;
determining a target resource contention feature of another model unit LG_{j,s} and the model unit LG_{i,n} on the candidate computing resource; wherein the other model unit LG_{j,s} represents a j-th model unit in an s-th network model among the plurality of network models;
obtaining target deceleration time corresponding to the model unit LG_{i,n} based on the theoretical execution time t(LG_{i,n},ST(LG_{i,n})) required for the model unit LG_{i,n} to execute the task on the candidate computing resource as well as the target resource contention feature of another model unit LG_{j,s} and the model unit LG_{i,n} on the candidate computing resource; and
obtaining actual execution time required for the model unit LG_{i,n} to execute the task on the candidate computing resource based on the theoretical execution time required for the model unit LG_{i,n} to execute the task on the candidate computing resource as well as the target deceleration time corresponding to the model unit LG_{i,n}.

16. A non-transitory computer-readable storage medium storing a computer instruction thereon, wherein the computer instruction is used to cause a computer to execute:
determining multiple types of computing resources and a plurality of network models required for the concurrent inference tasks, wherein the concurrent inference tasks represent a plurality of inference tasks to be processed in parallel, and each network model is used to execute at least one of the plurality of inference tasks;
determining actual execution time required for each model unit in the plurality of network models to execute a task on a candidate computing resource as well as actual resource switching time corresponding to each model unit, to obtain total execution time required to execute the concurrent inference tasks; wherein the actual resource switching time represents transition-in time required for the model unit to switch from another computing resource to the candidate computing resource and/or transition-out time required to switch from the candidate computing resource to another computing resource after completing the task; and the candidate computing resource is one of the multiple types of computing resources; and
using the total execution time to determine a target scheduling result, wherein the target scheduling result represents at least a target computing resource to be invoked, in a case of the model unit needs to execute at least some subtasks in an inference task.

17. The non-transitory computer-readable storage medium of claim 16, wherein the computer instruction is used to cause the computer to further execute:
using the target scheduling result to invoke the target computing resource, to execute at least some subtasks to be executed by a model unit corresponding to the target computing resource.

18. The non-transitory computer-readable storage medium of claim 16, wherein processing performance of a computing resource among the multiple types of computing resources is superior to processing performance of a CPU.

19. The non-transitory computer-readable storage medium of claim 18, wherein the multiple types of computing resources comprise: at least one GPU and at least one deep learning accelerator.

20. The non-transitory computer-readable storage medium of claim 16, wherein the determining actual execution time required for each model unit in the plurality of network models to execute a task on a candidate computing resource, comprises:
determining theoretical execution time t(LG_{i,n},ST(LG_{i,n})) required for a model unit LG_{i,n} to execute a task on a candidate computing resource; wherein the model unit LG_{i,n} represents an i-th model unit in a n-th network model among the plurality of network models; and
ST(LG_{i,n}) represents the candidate computing resource where the model unit LG_{i,n} executes the task;
determining a target resource contention feature of another model unit LG_{j,s} and the model unit LG_{i,n} on the candidate computing resource; wherein the other model unit LG_{j,s} represents a j-th model unit in an s-th network model among the plurality of network models;
obtaining target deceleration time corresponding to the model unit LG_{i,n} based on the theoretical execution time t(LG_{i,n},ST(LG_{i,n})) required for the model unit LG_{i,n} to execute the task on the candidate computing resource as well as the target resource contention feature of another model unit LG_{j,s} and the model unit LG_{i,n} on the candidate computing resource; and
obtaining actual execution time required for the model unit LG_{i,n} to execute the task on the candidate computing resource based on the theoretical execution time required for the model unit LG_{i,n} to execute the task on the candidate computing resource as well as the target deceleration time corresponding to the model unit LG_{i,n}.
